(19) United States
(12) Patent Application Publication
(10) Pub. No.: US 2004/0047332 A1
(43) Pub. Date: Mar. 11, 2004

(54) Process and system for subscription sharing between a plurality of radiotelephony terminals

(76) Inventors: Michael Bensimon, Grenoble (FR); Philippe Caloud, Saint Ismier (FR); Nicolas Prunel, Grenoble (FR)

Correspondence Address: PERMAN & GREEN, 425 POST ROAD, FAIRFIELD, CT, 06824, US

(21) Appl. No.: 10/463,095

(22) Filed: Jun. 17, 2003

(30) Foreign Application Priority Data
Jun. 18, 2002 (FR) 0207660

(51) Int. Cl. H04B 7/212; H04Q 7/20

(52) U.S. Cl. 370/347; 455/450

(57) ABSTRACT

The present invention relates to a process and a system for subscription sharing between a plurality of radiotelephone terminals (20a to 20e), with a unique telephone number associated with the plurality of terminals. In particular, the process is characterised in that it includes a first step wherein a manager shares out a period of access to a radiotelephony network, under the subscription, into time slots and wherein the manager allocates specific time slots to each terminal (20a to 20e), the time slots allocated to the different terminals (20a to 20e) not overlapping, a second step wherein the time slots specific to each terminal (20a to 20e) are transmitted (53a, 53b) from one or more synchronisation servers (1) to each terminal (20a to 20e), and a third step wherein the specific time slots are stored in the memory of each terminal (20a to 20e) to which said time slots have been allocated. The invention also relates to a system allowing the process to be implemented.

The present invention relates to a process and a system for subscription sharing between a plurality of radiotelephony terminals. A unique telephone number is associated with this plurality of terminals.

The invention is particularly useful for managing pieces of equipment located at a distance from each other in places that do not have a wired telephone network.

This is the case, for example, for the EDF company, which has to manage transformers throughout France. The process according to the invention makes it possible, by allocating a terminal to each transformer in the EDF stock, to transmit by radiotelephony, for example through the GSM network, various data types from each terminal to a single management centre, the data being able to include, for example, the measurement at regular intervals of different physical quantities such as power, temperature, pressure, etc.

This is also the case for companies having a team of representatives, the invention allowing order taking to be transmitted almost instantaneously.

It is again the case for itinerant equipment monitoring or inspection services, the invention allowing an employee to take measurements, to record them on his terminal, and then to transmit them without having to obtain a communication with someone from the management centre.

Generally speaking, a subscription relates to an individual in possession of a radiotelephone terminal, each terminal being fitted with a chip card known as a SIM, which includes all the data relating to the subscriber. A call number known as MSISDN and an international terminal identity known as IMEI are associated with each terminal. An international subscriber identity known as IMSI is associated with the subscriber.

It should be stated that a terminal is able to present three distinct states:

connected to the radiotelephony network,

disconnected from the radiotelephony network

currently transmitting (and also connected therefore to the radiotelephony network).

There is a system, known through the European patent application EP 0 711 090, which allows a plurality of users in possession of a GSM terminal to share the same subscription. A unique IMSI identity is allocated to all the user terminals. On the other hand, each terminal has a specific IMEI. Each user can thus be identified by a combination of the IMSI and IMEI identities. Several of the users sharing several SIM cards with the same subscription may then use their SIM cards at the same time. If someone tries to get in touch with one of the users sharing said subscription, this person will be offered a list of the different users sharing the subscription and will have to select the user for whom the call is intended in order to be put in contact with him. This system is provided for family use. One drawback of this system is that it is restrictive for large companies, since a user will have to be selected from a long list of users. Another drawback of this system is that each terminal is obliged to send, at each start-up and at each transmission, an identification message including the IMEI and IMSI identities to enable the sender to be identified. In fact, a sender is really identified by means of the IMSI (which has a direct correspondence with the MSISDN number), and, if the IMEI is to be used as an identifier, filtering is required, which considerably complicates the process. An additional drawback of this system is that system management becomes increasingly complex. Indeed the alarms generated when twin SIM cards are used, and which allow these twin SIM cards to be identified and at the same time pirated twin SIM cards which are incorrectly cloned to be detected, become a source of pollution in monitoring centres if the pirated SIM cards are correctly cloned. It is then necessary to find another means of detecting pirated SIM cards, which complicates the system.

A first purpose of the invention is to propose a process for allowing the sharing of a single subscription to a radiotelephony network, shared between a plurality of radiotelephone terminals, without the need to transmit the terminal identity at each transmission.

This purpose is fulfilled by a process of sharing a subscription between a plurality of terminals fitted with radiotelephony means, characterised in that it includes a first step wherein a manager shares out a period of access to a radiotelephony network, under the subscription, into time slots, and wherein the manager allocates specific time slots to each terminal, the time slots allocated to the different terminals not overlapping, a second step wherein the time slots specific to each terminal are transmitted from one or more synchronisation servers to each terminal, and a third step wherein the specific time slots are stored in a memory of each terminal to which said time slots have been allocated.

According to another feature, the memory of each terminal is a SIM card.

According to another feature, the process includes a step wherein the clock of each terminal is synchronised, at set intervals, with that of the servers synchronising and storing clock data in the terminal memory.

According to another feature, the synchronisation step consists of the transmission, from one or more synchronisation servers to each terminal, of a synchronisation message containing the date and time of the synchronisation server or servers clock, then of a step wherein this message is processed by the circuits of each terminal and the programme so as to update the clock of each terminal.

According to another feature, the synchronisation step consists in updating the clocks of the synchronisation servers and of each terminal from GPS systems connected to the synchronisation servers and to each terminal.

According to another feature, the process includes a step wherein each terminal connects to the radiotelephony network, triggered by a monitoring programme portion of each terminal, when said terminal is in a time slot that is allocated to it.

According to another feature, the process includes a step wherein each terminal disconnects from the radiotelephony network at the end of the time slot that is allocated to it, triggered by a monitoring programme portion of each terminal.

According to another feature, the process includes a step wherein data is transmitted, via the radiotelephony network, from each terminal to one or more application servers, when said terminal is in a time slot where it is connected to the radiotelephony network, the data containing the data on the clock and on physical quantities, measured or input at pre-set intervals using measurement or input means.

According to another feature, the process includes a step wherein each application server is synchronised with the synchronisation servers by sending a synchronisation message from the synchronisation servers to each application server.

According to another feature, the process includes a step wherein each terminal is contacted by at least one synchronisation server or one application server in the time slot that is allocated to said terminal, consisting of the sending of a message including new time slots and/or new synchronisation information, or allowing the data exchange between said terminal and the application server to be activated.

According to another feature, the process includes, when a terminal is in a time slot where it is connected to the radiotelephony network, a step wherein data transmission time is requested by said terminal from at least one synchronisation server, followed by a step wherein transmission time is allocated to said terminal by the synchronisation server for exchanging data with at least one application server, the data transmission time using a second subscription.

According to another feature, the process includes, when a terminal is in a time slot where it is connected to the radiotelephony network, a step wherein a compulsory data transmission time is allocated by at least one synchronisation server to said terminal, so that said terminal exchanges data with at least one application server.

Another purpose of the invention is to propose a system for implementing the process according to the invention.

This purpose is fulfilled by a system, characterised in that it includes at least one synchronisation server and one application server, the synchronisation server including at least computing means allowing a period of access to a radiotelephony network by a plurality of radiotelephone terminals to be managed and defined and a memory allowing time slots allocated to each terminal to be recorded, and the application server including at least computing means allowing data transmitted by each terminal to be managed and a memory allowing this data to be recorded.

According to another feature, the synchronisation server is merged with the application server.

According to another feature, the synchronisation server is connected to a radiotelephony network and comprises means for transmitting, to each terminal sharing the same subscription, the data defining the time slots that have been allocated to it.

According to another feature, each radiotelephone terminal includes means for transmitting data stored in a memory of said terminal, representing physical quantities measured at set intervals by measurement means connected to said terminal, and date and time transmission means.

According to another feature, all the terminals have an identical SIM card.

According to another feature, each terminal may be connected to a GPS-type synchronisation system.

Other features and advantages of the present invention will emerge more clearly from reading the description given hereinafter with reference to the appended drawings, in which:

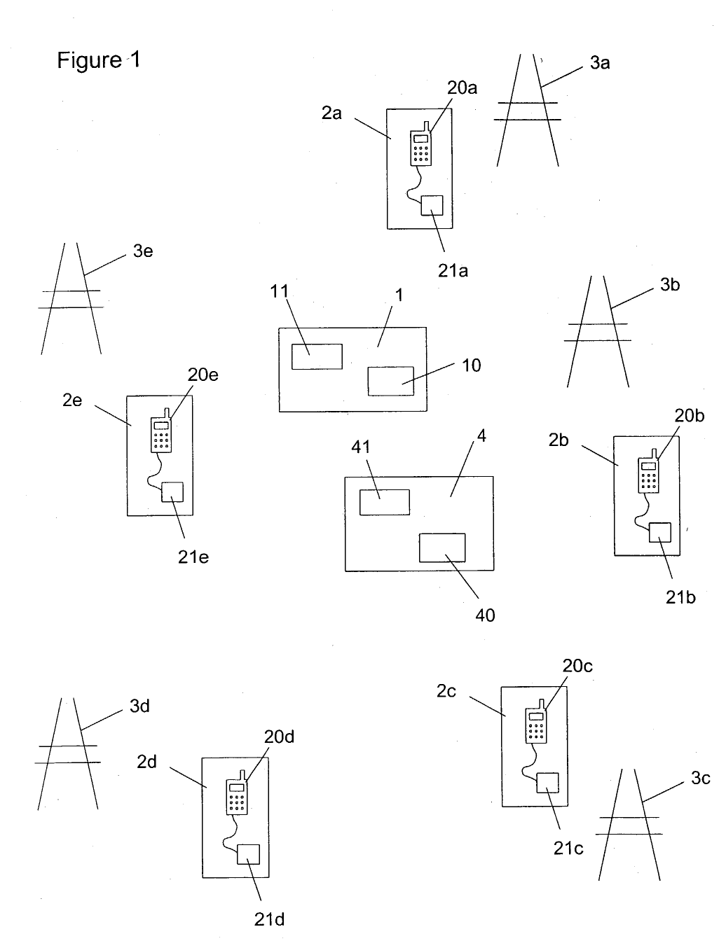

FIG. 1 shows the diagram of a mode of implementation of the process according to the invention,

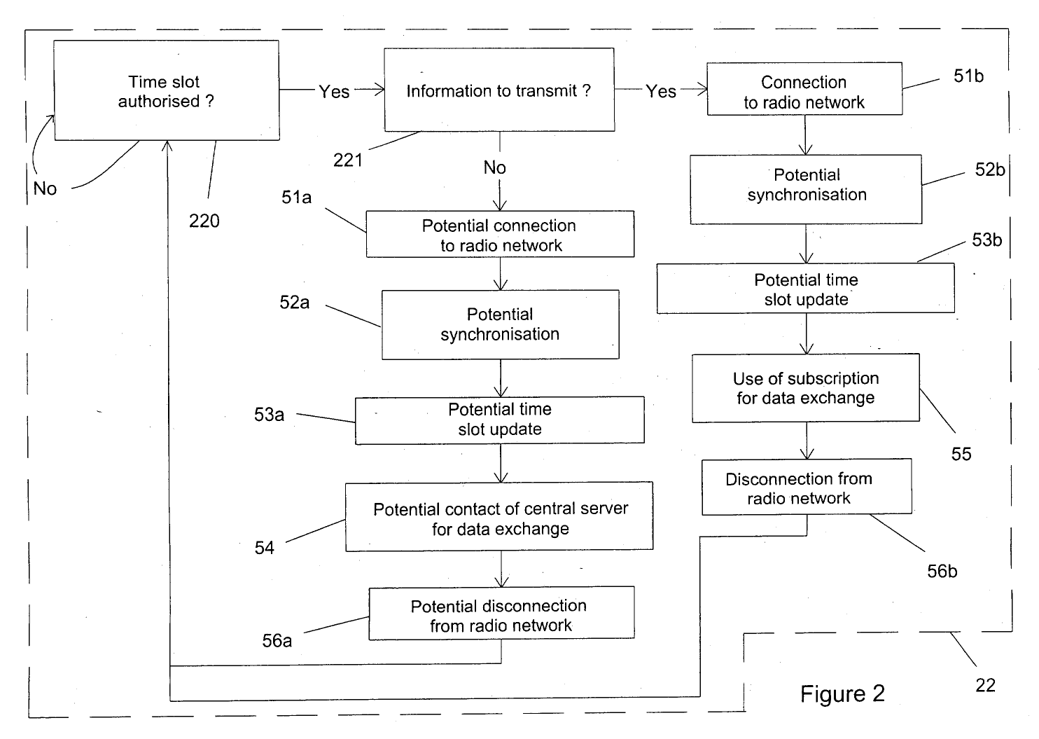

FIG. 2 shows the block diagram of the process according to the invention.

As shown in FIG. 1, the process according to the invention applies to a plurality of terminals (20a to 20e) to which are allocated the same MSISDN telephone number, the same IMSI identity and the same Ki authentication key. A single subscription is shared between the different terminals (20a to 20e). Each terminal concerned includes a SIM card provided with the same subscription information. According to the embodiment in FIG. 1, each terminal fits out with a measurement or inspection piece of equipment (2a to 2e), this piece of equipment being, for example, an EDF transformer. Each piece of equipment (2a to 2e) includes a grouping (21a to 21e) of means for measuring different physical quantities such as, for example, power, temperature and atmospheric pressure. The measurement means of each grouping (21a to 21e) are, for example, a wattmeter, a thermometer and a barometer. The data measured at set intervals by each measurement means grouping (21a to 21e) are recorded in the memory or the SIM card of each terminal (20a to 20e).

Let us note that in FIG. 1 only five pieces of equipment (2a, 2b, 2c, 2d, 2e) are shown. The invention may however apply to a much larger number of pieces of equipment.

A set of time slots for connecting to the central radiotelephony network is allocated to each terminal (20a to 20e) by one or more synchronisation servers (1). The fact that a single synchronisation server (1) is shown in FIG. 1 must in no way be taken as restrictive. This set of time slots is different for each terminal (20a to 20e), such that the different time slots of the different terminals (20a to 20e) do not overlap. Each time slot allocated to each terminal (20a to 20e) is recorded on the SIM card of the corresponding terminal (20a to 20e). Each terminal (20a to 20e) can therefore only connect to the telephone network during the time slots that are allocated to it. These time slots are preferably transmitted to each terminal by the synchronisation server (1) nearest to said terminal when a first communication is established by said synchronisation server with the terminal. To avoid the time slots of several terminals (20a to 20e) from overlap it is necessary for the date and time of all terminals to be the same more or less one delta.

Each synchronisation server (1) includes at least one microprocessor (10), one memory (11) and man-machine interface means. The microprocessor (10) of the synchronisation server (1) makes it possible in particular, through the execution of a program and the synchronisation server (1) interface means, to allocate and to manage the time slots of the different terminals (20a to 20e). The set of time slots allocated to each terminal (20a to 20e) is recorded in the memory (11) of the synchronisation server (1). Only the time slots allocated to the nearest terminals managed by a certain synchronisation server can be recorded in the memory (11) of said synchronisation server (1) if a central server manages the correspondence between the different terminals and the synchronisation server with which they communicate.

When a terminal (20a to 20e) enters a time slot that is allocated to it, its monitoring program detects the start of the time slot and connects to the radiotelephony network (51a, 51b), as is shown in FIG. 2, for example by activating its radio radiotelephone interface. Said terminal (20a to 20e) is then able to transmit data to one or more application servers (4) using the shared subscription according to the invention (55). The data is transmitted by each terminal through a cellular radiotelephony network, for example the GSM network, to the earth base station (3a to 3b) nearest to each terminal. The data is then transmitted by said earth base station (3a to 3e) through the wired telephone network to the application server or servers (4), responsible for collecting the data. The fact that a single application server (4) is shown in FIG. 1 must in no way be taken as restrictive. The application server or servers (4) may be merged with the synchronisation server or servers (1). Each application server (4) includes at least one microprocessor (40), one memory (41) and man-machine interface means. The microprocessor (40) of the application server (4) makes it possible in particular, through the execution of a program and the application server (4) interface means, to manage the data received from the different terminals (20a to 20e). The memory (41) of the application server (4) allows this data to be recorded. The memory (41) of the application server (4) also includes the time slots allocated to each terminal, which are updated at set intervals by the synchronisation server(s) (1).

The data transmitted by a terminal (20a to 20e) to the application server(s) (4) contains at least the measured physical quantities, as well as the transmission date and time. The transmission date and time data allow the microprocessor (40) of the application server or servers (4), by consulting the memory (41), to identify the terminal (20a to 20e) that has transmitted the data. In a variant of the invention, the terminal (20a to 20e) is identified by its IMEI identifier or by any other identifier.

When a terminal (20a to 20e) is connected to the radiotelephony network, the synchronisation server (or servers) (1) is (are) able to send to said terminal (20a to 20e) a message containing the current date and time so that said terminal records an update of the current date and time in place of the previously recorded date and time, and synchronises its clock (52a, 52b). The synchronisation server (or servers) (1) sends (send) the same message to the application server(s) (4) so that it (they) can also synchronise its (their) clock(s). Indeed, it is important for all the terminals, the synchronisation server(s) and the application server(s) to be at the same date and time so as to avoid the time slots of the different terminals (20a to 20e) from overlapping and so that the synchronisation servers (1) and the application servers (4) are able to contact the different terminals without having to use a terminal identifier, but only the time slots. As it happens, the clock of each terminal (20a to 20e) and server (1, 4) may experience a degree of drift relative to the date and time of the other terminals (20a to 20e) and servers (1, 4). Furthermore, to optimise the subscription, it is necessary for the time slots allocated to the different terminals (20a to 20e) to run sequentially one after the other. The error range on the update time corresponds to the message round-trip time.

In a variant of the invention, each terminal (20a to 20e), and each server (1, 4), is connected to a GPS system that provides both an absolute position with an accuracy of about 10 metres, and a time datum to an accuracy of a microsecond. Each GPS system in fact receives this information from satellites including an oscillator supplying a frequency calibrated on atomic clocks. In this variant, the clocks of each terminal (20a to 20e) and of each server (1, 4) are regularly updated using the GPS system. The synchronisation servers (1) do not then need to update the date and time of each terminal (20a to 20e) and of each application server (4).

In the event of synchronisation between two terminals (20a to 20e) not being perfect, these two terminals (20a to 20e) may be connected at the same time to the radiotelephony network and transmit at the same time, unless they are in the same route switching cell. On the other hand, two terminals cannot be connected at the same time. So, when two terminals (20a to 20e) transmit data at the same time, the synchronisation server (or servers) (1) synchronises (or synchronise) the clocks of these two terminals at least and possibly update their time slots. In this case the synchronisation server (or servers) (1) sends (or send), with the synchronisation and time slot update message, an identifier of the terminals concerned, for example their IMEI, so that each of the terminals recognises the message that is allocated to it, each terminal being in possession of this said identifier, which is recorded in its memory or its SIM card.

When a terminal (20a to 20e) is connected to the radiotelephony network, the synchronisation server (or servers) (1) is (are) able to transmit to said terminal (20a to 20e) an update of all the time slots (53a, 53b) corresponding to said terminal, when a modification has been made to this set of time slots by an installation manager.

The program (22) of the terminal (20a to 20e) includes a terminal monitoring loop (220), which detects entry into an authorised time slot. The program (22) inspects the memory zones of the terminal (20a to 20e) or of the SIM card so as to determine, using a test (51), if there is information to transmit.

If not, the program (22) continues with a step (52b) wherein the transmission time slots are possibly synchronised and a step (53a) wherein they are possibly updated. Before the disconnection step (56a), the program (22) is able to allow a step (54) wherein the synchronisation or application servers (1, 4) contact the terminal (20a to 20e) so that they transmit to the terminal (20a to 20e) data intended for the application connected to the radiotelephone terminal (20a to 20e).

If yes, the program (22) continues with a step (52b) wherein the clock is possibly synchronised and a step (53b) wherein the transmission time slots of the terminal (20a to 20e) are possibly updated. The terminal (20a to 20e) is then authorised to transmit (55) data to the application server or servers (4). Each synchronisation or application server (1, 4) may also, during the step (55), transmit to the terminal (20a to 20e), before the disconnection step (56b), data intended for the application connected to the radiotelephone terminal.

When a terminal (20a to 20e) leaves a time slot that is allocated to it, its monitoring program detects the end of the time slot and disconnects from the radiotelephony network (56a, 56b), as is shown in FIG. 2, for example by making its radiotelephone interface inactive.

The synchronisation or application servers (1, 4) are able to contact a terminal (20a to 20e) which is connected, but which is not actually transmitting, in order for example to update the clock or the time slots of said terminal (20a to 20e), to request from said terminal (20a to 20e) a confirmation of the absence of data for transmission, or else to update a software.

In a variant of the invention, two subscriptions are used instead of just one. This variant is useful in the event of the volume of data for exchange being substantial. The first subscription is used only for synchronising and updating the time slots of the terminals (20a to 20e). When a terminal is connected to the radiotelephony network during a time slot that is allocated to it, said terminal is able to ask the synchronisation server or servers (1), by means of a transmission entitlement message, to assign it a time for transmitting to the application server or servers (4) for the purpose of exchanging data, for example by a system of tokens. The synchronisation server or servers (1) may also order said terminal to take this time for transmitting to the application server or servers (4) for the purpose of exchanging data. The transmission entitlement message may, for example, include the number of the application server (4) to be contacted. Data will be exchanged with the application server or servers (4) by means of the second subscription. The use of a double subscription system makes it possible, on the one hand, to reduce the risks of simultaneous transmission by several terminals, and, on the other hand, to increase the number of time periods during which a terminal may potentially be connected or transmit.

It should be pointed out that when a terminal is connected to the radiotelephony network, a user of this terminal may call another physical person using said terminal, for example to transmit collected data personally.

It must be obvious, to those skilled in the art, that the present invention allows embodiments in many other specific forms, without departing from the field of application of the invention as claimed. Consequently, the present embodiments must be considered as examples, but can be modified in the field defined by the scope of the attached claims, and the invention must not be restricted to the details given above.

What is claimed is:

1. Process of sharing a subscription between a plurality of terminals fitted with radiotelephony means, characterised in that it includes a first step wherein a manager shares out a period of access to a radiotelephony network, under the subscription, into time slots, and wherein the manager allocates specific time slots to each terminal, the time slots allocated to the different terminals not overlapping, a second step wherein the time slots specific to each terminal are transmitted from one or more synchronisation servers to each terminal, and a third step wherein the specific time slots are stored in a memory of each terminal to which said time slots have been allocated.

2. Process according to claim 1, characterised in that the memory of each terminal is a SIM card.

3. Process according to claim 1, characterised in that it includes a step wherein the clock of each terminal is synchronised, at set intervals, with that of the servers synchronising and storing clock data in the terminal memory.

4. Process according to claim 3, characterised in that the synchronisation step consists of the transmission, from one or more synchronisation servers to each terminal, of a synchronisation message containing the date and time of the clock of the synchronisation server or servers clock, then of a step wherein this message is processed by the circuits of each terminal and the programme so as to update the clock of each terminal.

5. Process according to claim 3, characterised in that the synchronisation step consists in updating the clocks of the synchronisation servers and of each terminal from GPS systems connected to the synchronisation servers and to each terminal.

6. Process according to claim 1, characterised in that the process includes a step wherein each terminal connects to the radiotelephony network, triggered by a monitoring programme portion of each terminal, when said terminal is in a time slot that is allocated to it.

7. Process according to claim 6, characterised in that it includes a step wherein each terminal disconnects from the radiotelephony network at the end of the time slot that is allocated to it, triggered by a monitoring programme portion of each terminal.

8. Process according to claim 3, characterised in that it includes a step wherein data is transmitted, via the radiotelephony network, from each terminal to one or more application servers, when said terminal is in a time slot where it is connected to the radiotelephony network, the data containing the data on the clock and on the physical quantities, measured or input at pre-set intervals using measurement or input means.

9. Process according to claim 7, characterised in that it includes a step wherein each application server is synchronised with the synchronisation servers by sending a synchronisation message from the synchronisation servers to each application server.

10. Process according to claim 7, characterised in that it includes a step wherein each terminal is contacted by at least one synchronisation server or one application server in the time slot that is allocated to said terminal, consisting of the sending of a message including new time slots and/or new synchronisation information, or allowing the data exchange between said terminal and the application server to be activated.

11. Process according to claim 6, characterised in that it includes, when a terminal is in a time slot where it is connected to the radiotelephony network, a step wherein data transmission time is requested by said terminal from at least one synchronisation server, followed by a step wherein transmission time is allocated to said terminal by the synchronisation server for exchanging data with at least one application server, the data transmission time using a second subscription.

12. Process according to claim 6, characterised in that it includes, when a terminal is in a time slot where it is connected to the radiotelephony network, a step wherein a compulsory data transmission time is allocated by at least one synchronisation server to said terminal, so that said terminal exchanges data with at least one application server.

13. System allowing the process according to the invention to be implemented, characterised in it includes at least one synchronisation server and one application server, the synchronisation server including at least computing means allowing a period of access to a radiotelephony network by a plurality of radiotelephone terminals to be managed and defined and a memory allowing time slots allocated to each terminal to be recorded, and the application server including at least computing means allowing data transmitted by each terminal to be managed and a memory allowing this data to be recorded.

14. System according to claim 13, characterised in that the synchronisation server is merged with the application server.

15. System according to claim 13, characterised in that the synchronisation server is connected to a radiotelephony network and comprises means for transmitting, to each terminal sharing the same subscription, the data defining the time slots that have been allocated to it.

16. System according to claim 13, characterised in that each radiotelephone terminal includes means for transmitting data stored in a memory of said terminal, representing physical quantities measured at set intervals by measurement means connected to said terminal, and also date and time transmission means.

17. System according to claim 13, characterised in that all the terminals have an identical SIM card.

18. System according to claim 13, characterised in that each terminal may be connected to a GPS-type synchronisation system.
